(19) United States
(12) Patent Application Publication
(10) Pub. No.: US 2025/0175266 A1
(43) Pub. Date: May 29, 2025

(54) DOPPLER SHIFT REPORTING USING A TRACKING REFERENCE SIGNAL

(71) Applicant: QUALCOMM Incorporated, San Diego, CA (US)

(72) Inventors: Jing DAI, Beijing (CN); Chenxi HAO, Beijing (CN); Liangming WU, Beijing (CN); Chao WEI, Beijing (CN); Min HUANG, Beijing (CN); Wei XI, Beijing (CN); Hao XU, Beijing (CN)

(21) Appl. No.: 18/834,399

(22) PCT Filed: Mar. 17, 2022
(86) PCT No.: PCT/CN2022/081336

§ 371 Date: Jul. 30, 2024

(51) Int. Cl. H04B 17/318; H04B 17/20; H04L 5/00; H04W 24/10

(52) U.S. Cl. CPC H04B 17/318; H04B 17/254; H04L 5/0048; H04W 24/10

(57) ABSTRACT

Various aspects of the present disclosure generally relate to wireless communication. In some aspects, a user equipment (UE) may measure a tracking reference signal (TRS) to determine a Doppler shift associated with the UE. Accordingly, the UE may transmit a report indicating a quantized value of the Doppler shift. The quantized value is based at least in part on a duration associated with measuring the TRS and an interval associated with the TRS. Numerous other aspects are described.

### FIELD OF THE DISCLOSURE

Aspects of the present disclosure generally relate to wireless communication and to techniques and apparatuses for Doppler shift reporting using a tracking reference signal.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include measuring a tracking reference signal (TRS) to determine a Doppler shift associated with the UE. The method may further include transmitting a report indicating a quantized value of the Doppler shift, wherein the quantized value is based at least in part on a duration associated with measuring the TRS and an interval associated with the TRS.

Some aspects described herein relate to an apparatus for wireless communication at a UE. The apparatus may include a memory and one or more processors coupled to the memory. The one or more processors may be configured to measure a TRS to determine a Doppler shift associated with the UE. The one or more processors may be further configured to transmit a report indicating a quantized value of the Doppler shift, wherein the quantized value is based at least in part on a duration associated with measuring the TRS and an interval associated with the TRS.

Some aspects described herein relate to a non-transitory computer-readable medium that stores a set of instructions for wireless communication by a UE. The set of instructions, when executed by one or more processors of the UE, may cause the UE to measure a TRS to determine a Doppler shift associated with the UE. The set of instructions, when executed by one or more processors of the UE, may further cause the UE to transmit a report indicating a quantized value of the Doppler shift, wherein the quantized value is based at least in part on a duration associated with measuring the TRS and an interval associated with the TRS.

Some aspects described herein relate to an apparatus for wireless communication. The apparatus may include means for measuring a TRS to determine a Doppler shift associated with the apparatus. The apparatus may further include means for transmitting a report indicating a quantized value of the Doppler shift, wherein the quantized value is based at least in part on a duration associated with measuring the TRS and an interval associated with the TRS.

Some aspects described herein relate to a method of wireless communication performed by a network entity. The method may include transmitting a configuration associated with a TRS. The method may further include receiving a report indicating a quantized value of a Doppler shift associated with a UE, wherein the quantized value is based at least in part on a duration associated with measuring the TRS and an interval associated with the TRS.

Some aspects described herein relate to an apparatus for wireless communication at a network entity. The apparatus may include a memory and one or more processors coupled to the memory. The one or more processors may be configured to transmit a configuration associated with a TRS. The one or more processors may be further configured to receive a report indicating a quantized value of a Doppler shift associated with a UE, wherein the quantized value is based at least in part on a duration associated with measuring the TRS and an interval associated with the TRS.

Some aspects described herein relate to a non-transitory computer-readable medium that stores a set of instructions for wireless communication by a network entity. The set of instructions, when executed by one or more processors of the network entity, may cause the network entity to transmit a configuration associated with a TRS. The set of instructions, when executed by one or more processors of the network entity, may further cause the network entity to receive a report indicating a quantized value of a Doppler shift associated with a UE, wherein the quantized value is based at least in part on a duration associated with measuring the TRS and an interval associated with the TRS.

Some aspects described herein relate to an apparatus for wireless communication. The apparatus may include means for transmitting a configuration associated with a TRS. The apparatus may further include means for receiving a report indicating a quantized value of a Doppler shift associated with a UE, wherein the quantized value is based at least in part on a duration associated with measuring the TRS and an interval associated with the TRS.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of disaggregated base station architecture, in accordance with the present disclosure.

FIG. 4 is a diagram illustrating an example of a tracking reference signal (TRS), in accordance with the present disclosure.

FIG. 5 is a diagram illustrating an example associated with Doppler shift reporting using a TRS, in accordance with the present disclosure.

FIGS. 6A, 6B, and 6C are diagrams illustrating examples associated with measurement durations associated with a TRS, in accordance with the present disclosure.

FIGS. 7 and 8 are diagrams illustrating example processes associated with Doppler shift reporting using a TRS, in accordance with the present disclosure.

FIGS. 9 and 10 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

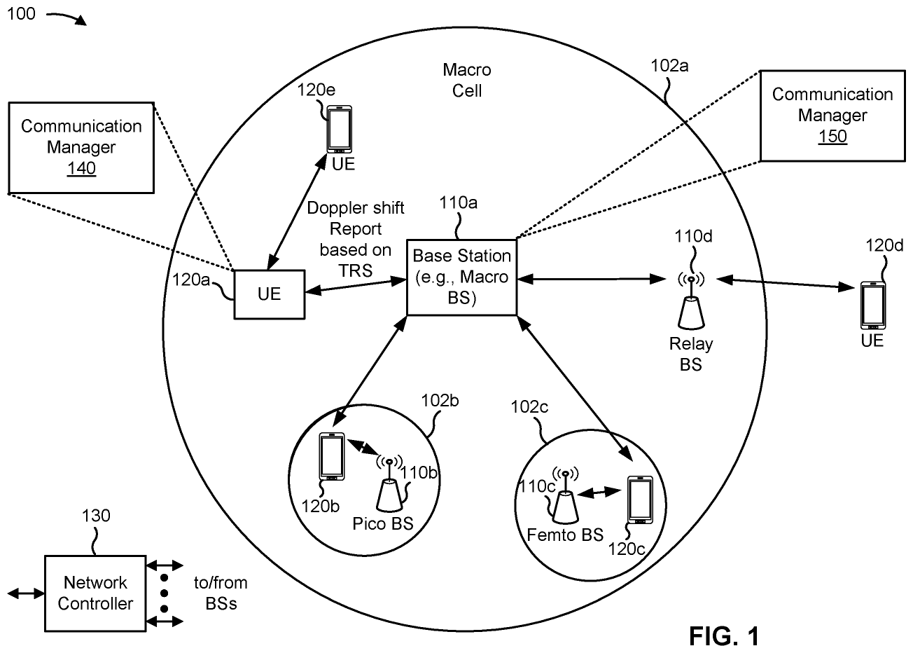

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

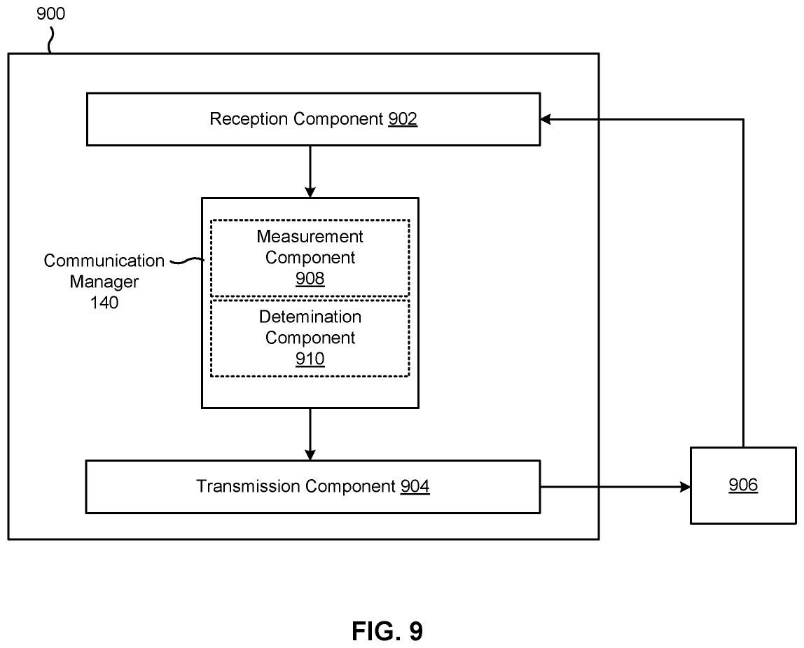

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As shown in FIG. 1 and described in more detail elsewhere herein, the communication manager 140 may measure a tracking reference signal (TRS) to determine a Doppler shift associated with the UE 120 and transmit a report indicating a quantized value of the Doppler shift, where the quantized value is based at least in part on a duration associated with measuring the TRS and an interval associated with the TRS. Additionally, or alternatively, the communication manager 140 may perform one or more other operations described herein.

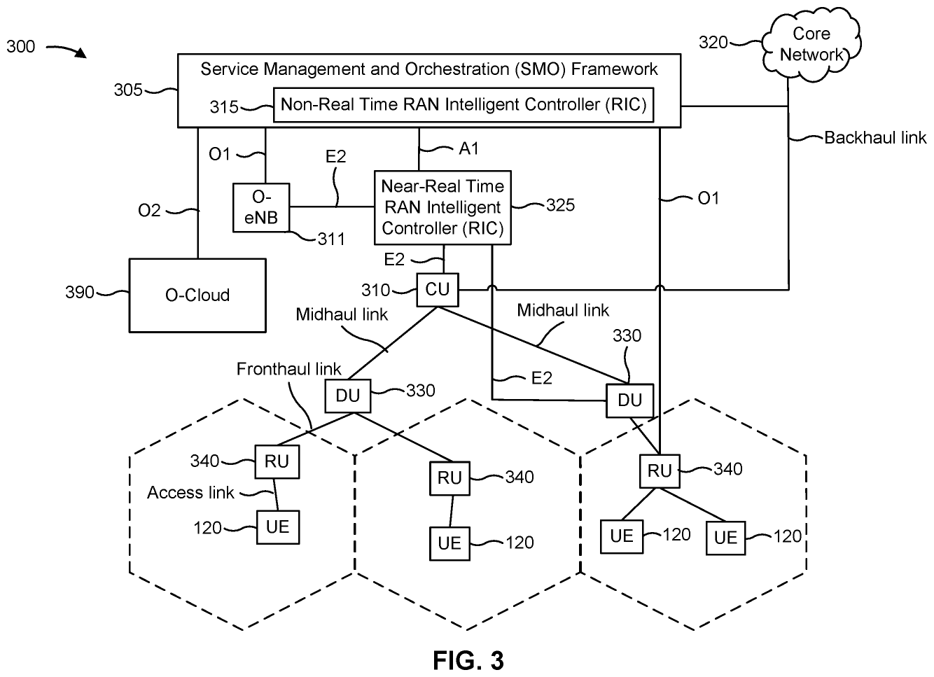

In some aspects, a network entity (e.g., the base station 110 and/or one or more components of a disaggregated base station architecture, as described in connection with FIG. 3) may include a communication manager 150. As shown in FIG. 1 and described in more detail elsewhere herein, the communication manager 150 may transmit a configuration associated with a TRS and receive a report indicating a quantized value of a Doppler shift associated with the UE 120, where the quantized value is based at least in part on a duration associated with measuring the TRS and an interval associated with the TRS. Additionally, or alternatively, the communication manager 150 may perform one or more other operations described herein.

As indicated above, FIG. 1 is provided as an example. Other examples may differ from what is described with regard to FIG. 1.

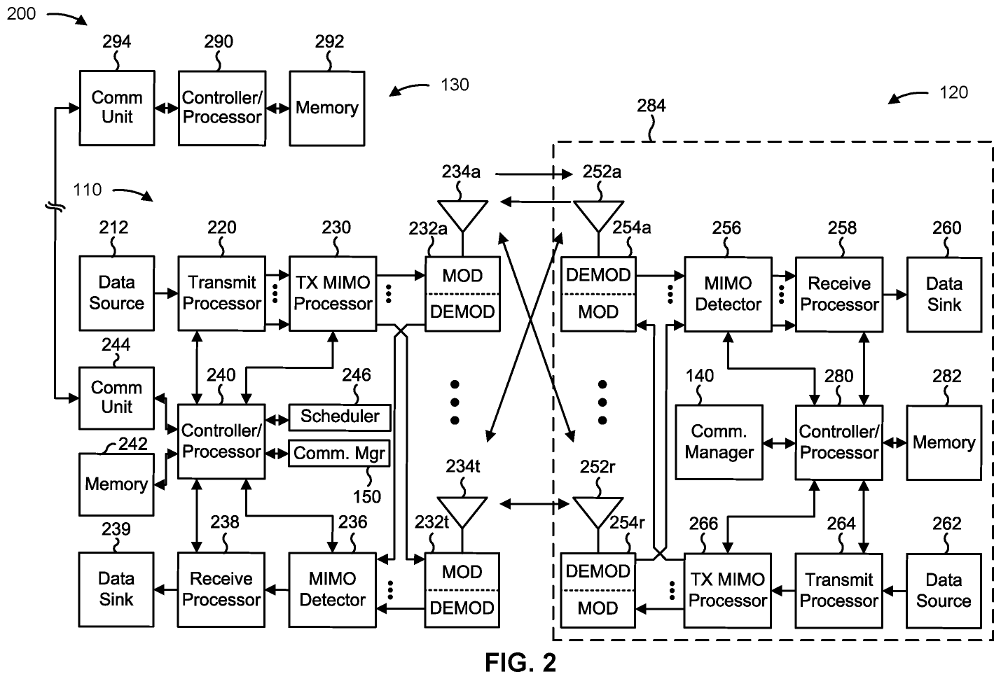

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

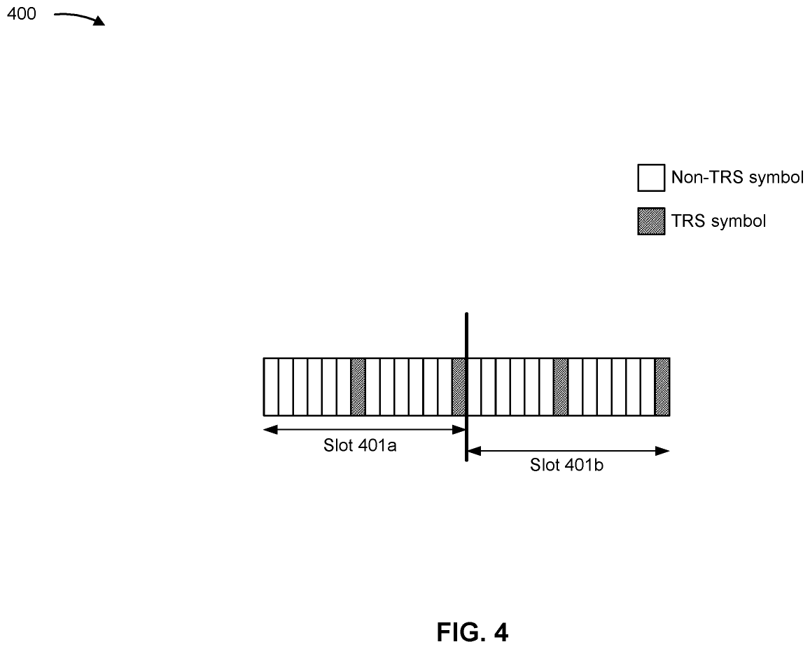

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

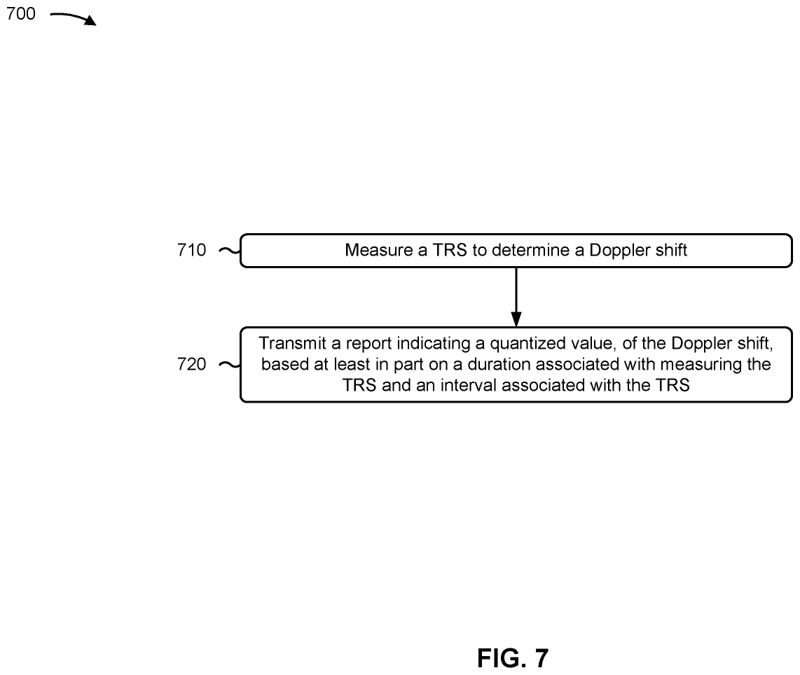

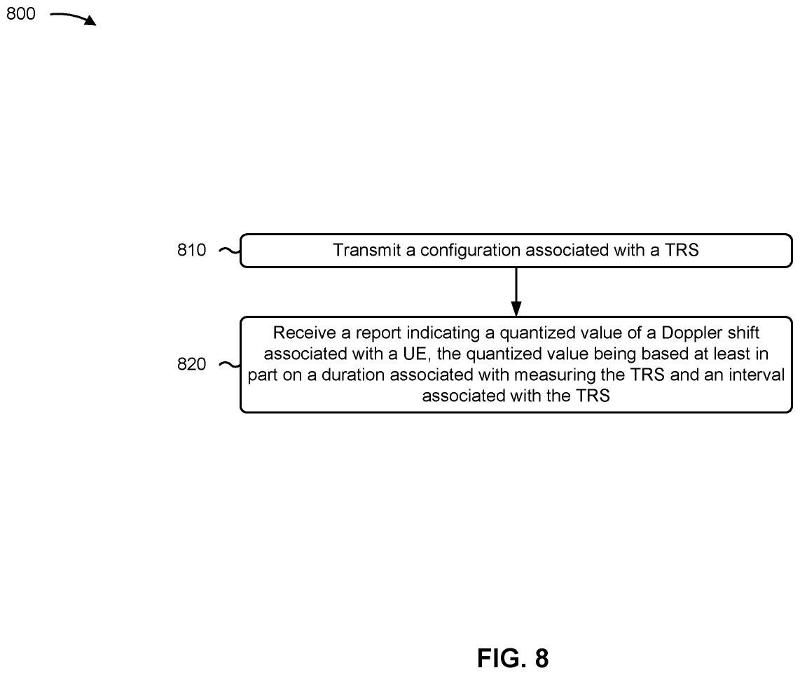

The controller/processor 240 of the base station 110, the controller/processor 280 of the UE 120, and/or any other component(s) of FIG. 2 may perform one or more techniques associated with Doppler shift reporting using a TRS, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples. In some aspects, the network entity described herein is the base station 110, is included in the base station 110, or includes one or more components of the base station 110 shown in FIG. 2.

In some aspects, a UE (e.g., UE 120 and/or apparatus 900 of FIG. 9) may include means for measuring a TRS to determine a Doppler shift associated with the UE and/or means for transmitting a report indicating a quantized value of the Doppler shift, wherein the quantized value is based at least in part on a duration associated with measuring the TRS and an interval associated with the TRS. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

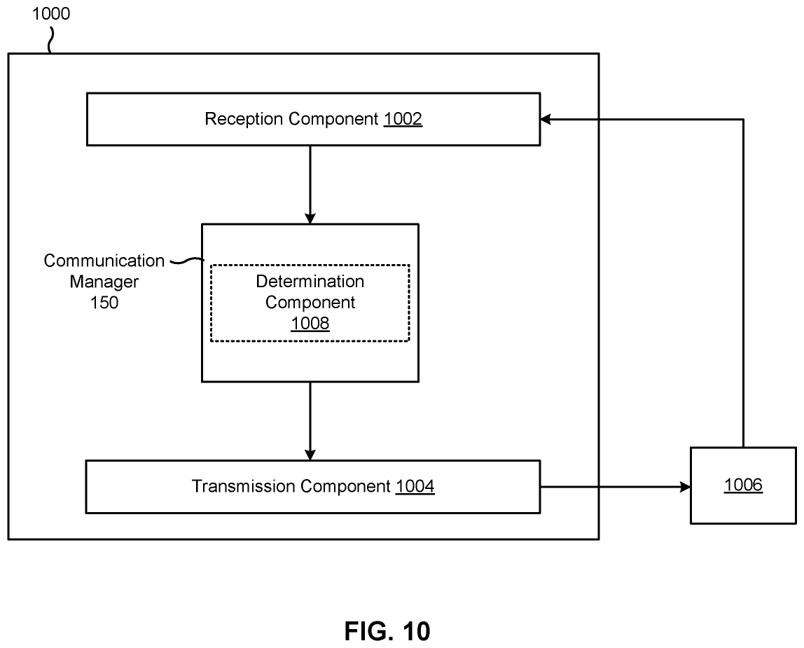

In some aspects, a network entity (e.g., base station 110, CU 310, DU 330, RU 340, and/or apparatus 1000 of FIG. 10) may include means for transmitting a configuration associated with a TRS and/or means for receiving a report indicating a quantized value of a Doppler shift associated with a UE (e.g., UE 120 and/or apparatus 900 of FIG. 9), wherein the quantized value is based at least in part on a duration associated with measuring the TRS and an interval associated with the TRS. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 disaggregated base station architecture, in accordance with the present disclosure. Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 is a diagram illustrating an example 400 of a TRS, in accordance with the present disclosure. Example 400 may include a single burst (or instance) of a periodic TRS (P-TRS), a single burst of a semi-persistent TRS (SP-TRS), or an aperiodic TRS (A-TRS). A network entity (e.g., a base station 110, a CU 310, a DU 330, and/or an RU 340) may generate and a transmit an NZP-CSI-RS-ResourceSet data structure (e.g., as defined in 3GPP specifications and/or another standard) in order to indicate (e.g., to a UE 120) the TRS. For example, the UE 120 may receive an RRC message including the NZP-CSI-RS-ResourceSet data structure. Accordingly, the network entity may indicate a set of channel state information (CSI) resources (e.g., in time, frequency, and/or space) that collectively form the TRS. Additionally, the network entity may set a trs-Info variable (e.g., as defined in 3GPP specifications and/or another standard) in the NZP-CSI-RS-ResourceSet data structure to TRUE (or to ‘1’) when indicating the TRS.

As shown in FIG. 4, the TRS may span a plurality of slots (e.g., slot 401a and slot 401b in example 400). As used herein, “slot” may refer to a portion of a subframe, which in turn may be a fraction of a radio frame within an LTE, 5G, or other wireless communication structure. In some aspects, a slot may include one or more symbols. Moreover, “symbol” may refer to an OFDM symbol or another similar symbol within a slot. Accordingly, as shown in FIG. 4, the TRS may include one or more symbols within the slot (e.g., the TRS is transmitted in two symbols of slot 401a and two symbols of slot 401b in example 400). In some aspects, as shown in FIG. 4, the TRS may be evenly spread over symbols across the plurality of slots (e.g., the TRS is including in one out of every seven symbols in example 400).

Some techniques and apparatuses described herein enable a network entity (e.g., a base station 110, a CU 310, a DU 330, and/or an RU 340) to configure a UE (e.g., UE 120) to measure a Doppler shift using a TRS. As a result, the network entity may conserve power and processing resources by using a TRS to obtain a Doppler shift associated with the UE 120 as compared with transmitting a new CSI reference signal (CSI-RS) or set of CSI-RSs. Additionally, the network entity may obtain higher resolution for the Doppler shift by using a longer measurement duration associated with the TRS as compared with a shorter measurement duration associated with a CSI-RS (or a set of CSI-RSs).

As indicated above, FIG. 4 is provided as an example. Other examples may differ from what is described with regard to FIG. 4.

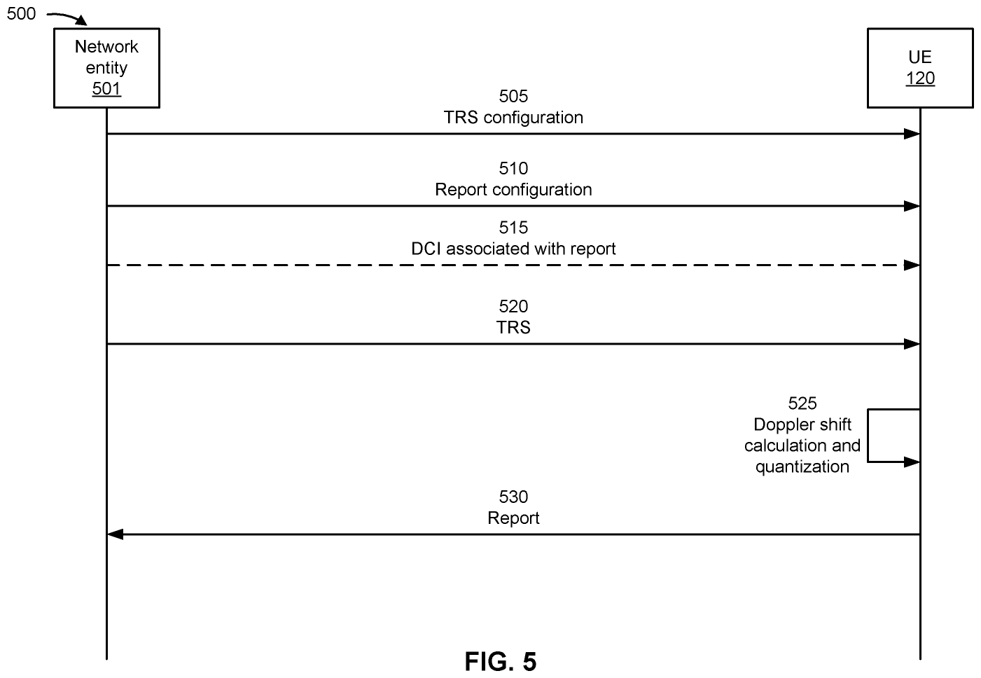

FIG. 5 is a diagram illustrating an example 500 associated with Doppler shift reporting using a TRS, in accordance with the present disclosure. As shown in FIG. 5, a network entity 501 (e.g., a base station 110, a CU 310, a DU 330, and/or an RU 340) and a UE 120 may communicate with one another. For example, the network entity 501 and the UE 120 may be included in wireless network 100 of FIG. 1.

As shown by reference number 505, the network entity 501 may transmit (e.g., wirelessly from the RU 340 and/or by sending commands to the RU 340), and the UE 120 may receive, a configuration associated with a TRS. For example, as described in connection with FIG. 4, the network entity 501 may transmit an RRC message including an NZP-CSI-RS-ResourceSet data structure (e.g., as described in 3GPP specifications and/or another standard) indicating the TRS. In some aspects, the network entity 501 may transmit a plurality of configurations, where each configuration is associated with a corresponding TRS. For example, the network entity 501 may transmit a plurality of NZP-CSI-RS-Resource Set data structures (e.g., as described in 3GPP specifications and/or another standard), where each data structure indicates a corresponding TRS and includes a corresponding identifier (e.g., an NZP-CSI-ResourceSetId, as described in 3GPP specifications and/or another standard).

Additionally, as shown by reference number 510, the network entity 501 may transmit (e.g., wirelessly from the RU 340 and/or by sending commands to the RU 340), and the UE 120 may receive, a configuration associated with a report (e.g., a report including a Doppler shift value). For example, the network entity 501 may generate and a transmit a CSI-ReportConfig data structure (e.g., as defined in 3GPP specifications and/or another standard) in order to indicate that the UE 120 should measure the TRS, as described in connection with reference number 505, and calculate a Doppler shift based on measuring the TRS. For example, the UE 120 may receive an RRC message including the CSI-ReportConfig data structure. Accordingly, the network entity may indicate the set of CSI resources that collectively form the TRS using an identifier associated with a corresponding NZP-CSI-RS-ResourceSet data structure (e.g., by including one or more an NZP-CSI-ResourceSetIds, as described in 3GPP specifications and/or another standard).

In some aspects, the network entity 501 indicates that the UE 120 should send the report periodically. Alternatively, the network entity 501 may indicate that the UE 120 should sent the report aperiodically. Accordingly, as shown by reference number 515, the network entity 501 may transmit (e.g., wirelessly from the RU 340 and/or by sending commands to the RU 340), and the UE 120 may receive, downlink control information (DCI) associated with the report. For example, the DCI may trigger the UE 120 to measure the TRS and transmit the report indicating a Doppler shift based on measuring the TRS, as described in connection with reference numbers 525 and 530. Additionally, or alternatively, the network entity 501 may transmit (e.g., wirelessly from the RU 340 and/or by sending commands to the RU 340), and the UE 120 may receive, a MAC control element (MAC-CE) associated with the report. For example, the MAC-CE (alone or in combination with DCI, as described above) may trigger the UE 120 to measure the TRS and transmit the report indicating a Doppler shift based on measuring the TRS, as described in connection with reference numbers 525 and 530.

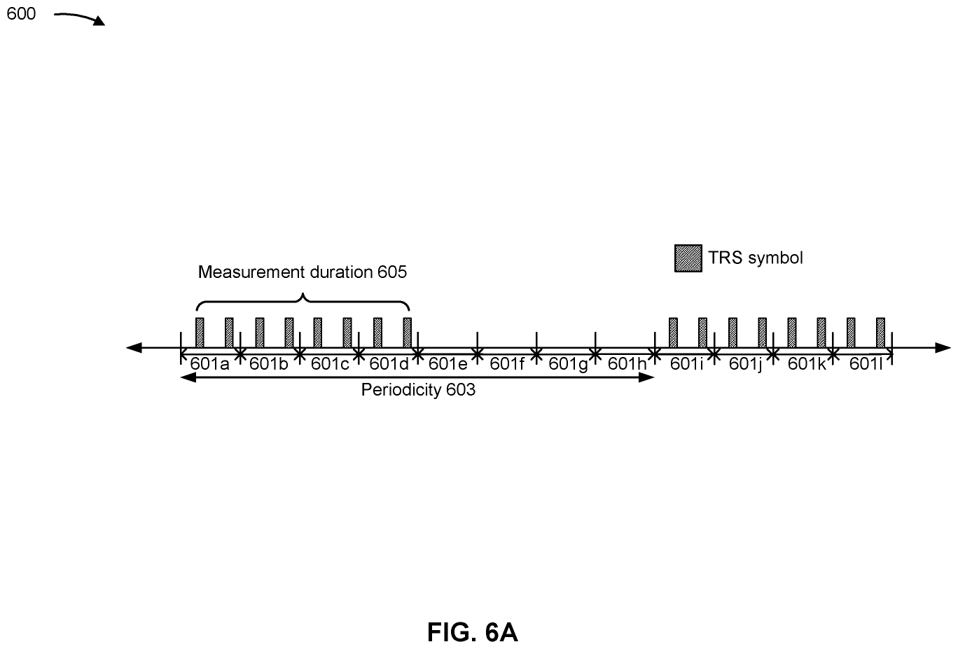

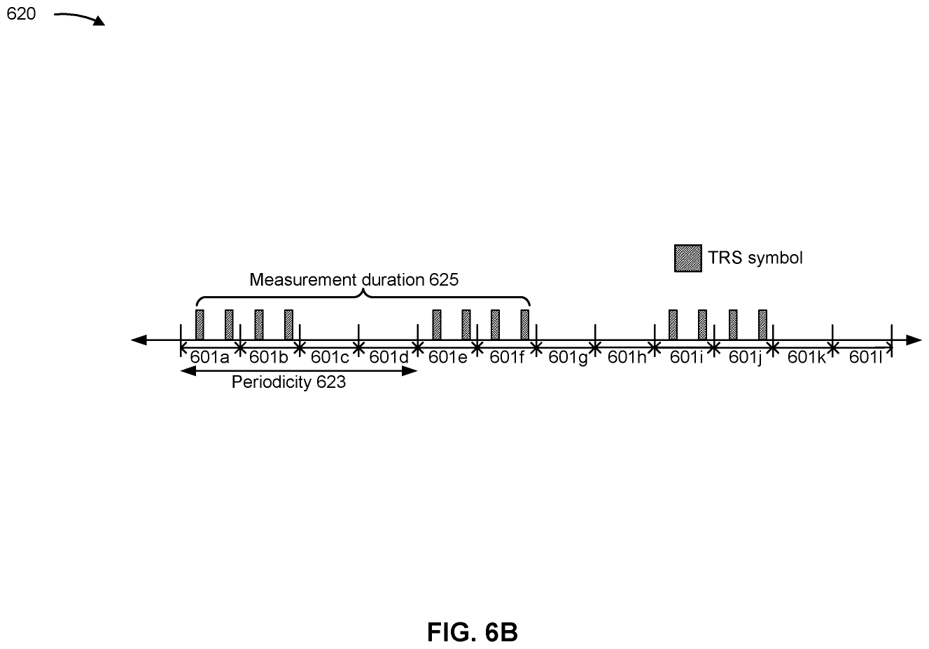

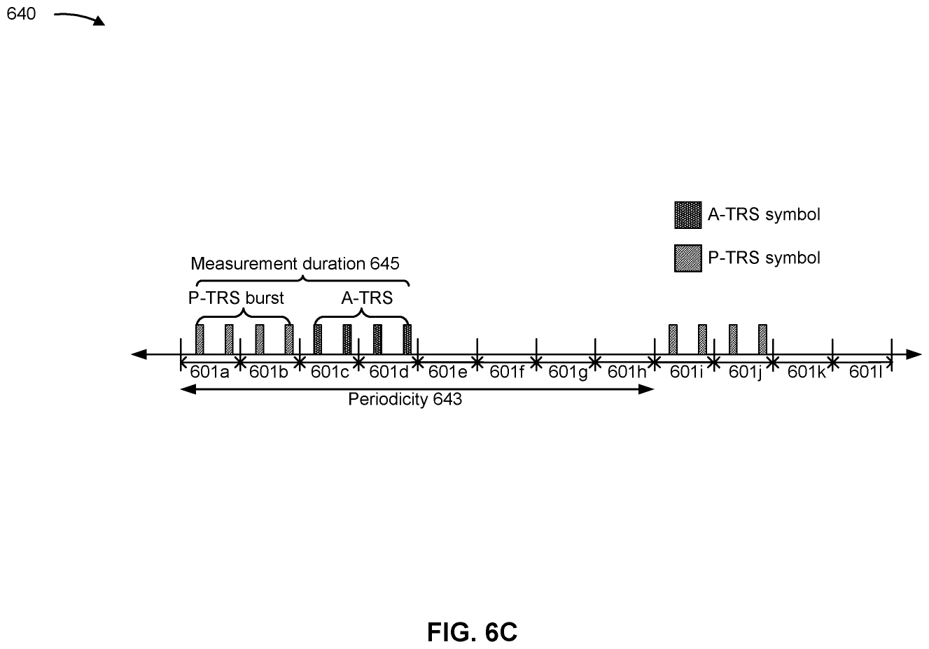

Accordingly, as shown by reference number 520, the network entity 501 may transmit (e.g., wirelessly from the RU 340 and/or by sending commands to the RU 340) the TRS, and the UE 120 may measure the TRS. The UE 120 may measure at least one burst of the TRS. For example, the network entity 501 may transmit, and the UE 120 may measure, a burst of the TRS that is longer than two slots, as described in connection with FIG. 6A. Additionally, or alternatively, the UE 120 may measure multiple bursts of the TRS, as described in connection with FIG. 6B. In some aspects, the network entity 501 may transmit, and the UE 120 may measure, a plurality of TRSs. For example, the network entity 501 may transmit, and the UE 120 may measure, at least one burst of a P-TRS (or an SP-TRS) in combination with at least one A-TRS, as described in connection with FIG. 6C.

As shown by reference number 525, the UE 120 may determine a Doppler shift associated with the UE 120. For example, the UE 120 may estimate the Doppler shift based on RSRPs and/or other measurements associated with the TRS.

As further shown by reference number 525, the UE 120 may determine a quantized value of the Doppler shift. In some aspects, the quantized value may include one or more bits indicating a range for the Doppler shift. In one example, the UE 120 may use a single bit to indicate whether the Doppler shift is above (or equal to) a value or is below (or equal to) a value. Other implementations may use more than one bit.

The range for the Doppler shift may be based at least in part on a maximum value (e.g., represented by |f_{D}|ₘₐₓ). Accordingly, in one example, the UE 120 may use three bits to indicate the Doppler shift. For example, a codepoint of 0 may indicate the Doppler shift is in a range

$$[ - {\vert {f}_{D} \vert}_{max} , - \frac{3}{4} {\vert {f}_{D} \vert}_{max} ) ,$$

a codepoint of 1 may indicate the Doppler shift is in a range

$$[ - \frac{3}{4} {\vert {f}_{D} \vert}_{max} , - \frac{1}{2} {\vert {f}_{D} \vert}_{max} ) ,$$

a codepoint of 2 may indicate the Doppler shift is in a range

$$[ - \frac{1}{2} {\vert {f}_{D} \vert}_{max} , - \frac{1}{4} {\vert {f}_{D} \vert}_{max} ) ,$$

a codepoint of 3 may indicate the Doppler shift is in a range

$$[ - \frac{1}{4} {\vert {f}_{D} \vert}_{max} , 0 ) ,$$

a codepoint of 4 may indicate the Doppler shift is in a range

$$[ 0 , \frac{1}{4} {\vert {f}_{D} \vert}_{max} ) ,$$

a codepoint of 5 may indicate the Doppler shift is in a

$$[ \frac{1}{4} {\vert {f}_{D} \vert}_{max} , \frac{1}{2} {\vert {f}_{D} \vert}_{max} ) ,$$

a codepoint of 6 may indicate the Doppler shift is in a range

$$[ \frac{1}{2} {\vert {f}_{D} \vert}_{max} , \frac{3}{4} {\vert {f}_{D} \vert}_{max} ) ,$$

and a codepoint of 7 may indicate the Doppler shift is in a range

$$[ \frac{3}{4} {\vert {f}_{D} \vert}_{max} , {\vert {f}_{D} \vert}_{max} ] .$$

Although described using ranges that are open-ended on upper ends, the UE 120 may instead quantize the Doppler shift using ranges that are open-ended on lower ends. For example, a codepoint of 0 may indicate the Doppler shift is in a range

$$[ - {\vert {f}_{D} \vert}_{max} , - \frac{3}{4} {\vert {f}_{D} \vert}_{max} ] ,$$

a codepoint of 1 may indicate the Doppler shift is in a range

$$( - \frac{3}{4} {\vert {f}_{D} \vert}_{max} , - \frac{1}{2} {\vert {f}_{D} \vert}_{max} ] ,$$

a codepoint of 2 may indicate the Doppler shift is in a range

$$( - \frac{1}{2} {\vert {f}_{D} \vert}_{max} , - \frac{1}{4} {\vert {f}_{D} \vert}_{max} ] ,$$

a codepoint of 3 may indicate the Doppler shift is in a range

$$( - \frac{1}{4} {\vert {f}_{D} \vert}_{max} , 0 ] ,$$

a codepoint or 4 may indicate the Doppler shift is in a range

$$( 0 , \frac{1}{4} {\vert {f}_{D} \vert}_{max} ] ,$$

a codepoint of 5 may indicate the Doppler shift is in a range

$$( \frac{1}{4} {\vert {f}_{D} \vert}_{max} , \frac{1}{2} {\vert {f}_{D} \vert}_{max} ] ,$$

a codepoint of 6 may indicate the Doppler shift is in a range

$$( \frac{1}{2} {\vert {f}_{D} \vert}_{max} , \frac{3}{4} {\vert {f}_{D} \vert}_{max} ] ,$$

and a codepoint of 7 may indicate the Doppler shift is in a range

$$( \frac{3}{4} {\vert {f}_{D} \vert}_{max} , {\vert {f}_{D} \vert}_{max} ] .$$

Although described using three bits, the description similarly applies to using fewer bits (e.g., two bits or one bit) and additional bits (e.g., four bits, five bits, and so on). Although described using uniform quantization, the UE 120 may apply non-uniform quantization to the Doppler shift.

In some aspects, the maximum value may be a default value stored on a memory of the UE 120 and/or a memory of the network entity 501. Alternatively, the maximum value may be a default value calculated by the UE 120 and/or the network entity 501. For example, the maximum value may be calculated using the duration associated with measuring the TRS (e.g., as described in connection with FIGS. 6A, 6B, and 6C) and the interval associated with the TRS (e.g., an amount of time between symbols including the TRS within a single burst of the TRS). Accordingly, the maximum value may be inversely proportional to the duration and the interval.

In some aspects, the maximum value may be further based, at least in part, on a carrier frequency (e.g., represented by f_{c}) associated with the TRS. For example, the maximum value may be inversely proportional to the carrier frequency.

Additionally, or alternatively, the maximum value may be indicated by the network entity 501 (e.g., in a transmission to the UE 120) or by the UE 120 (e.g., in a transmission to the network entity 501). For example, the network entity 501 may indicate a maximum value smaller than the default value for the UE 120 to use for quantization. In another example, the UE 120 may indicate a maximum value smaller than the default value based on one or more properties associated with the UE 120. For example, the UE 120 may indicate smaller maximum values when a moving speed associated with the UE 120 is slower (e.g., based on measurements of other signals from the network entity 501 and/or measurements from one or more sensors of the UE 120, such as an accelerometer, a global positioning system (GPS) component, and/or another type of motion sensor).

As shown by reference number 530, the UE 120 may transmit, and the network entity 501 may receive (e.g., wirelessly at the RU 340 and/or by receiving analog and/or digital signals from the RU 340 based on wireless signals from the UE 120), a report indicating the quantized value of the Doppler shift.

In some aspects, the UE 120 may transmit the report according to a CSI computation time. For example, the UE 120 may transmit the report a quantity of symbols (e.g., represented by Z for an offset from a last symbol of PDCCH (carrying DCI) triggering the report, and by Z′ for an offset from a last symbol of a latest aperiodic reference signal (for channel measurement or for interference measurement)) before a first symbol of an uplink channel carrying the report. Alternatively, the UE 120 may transmit the report a quantity of symbols (e.g., represented by Z′) after a latest aperiodic TRS resource that was measured, until a first symbol of an uplink channel carrying the report.

In one example, the quantity of symbols may be represented by Z₁ or Z′₁ and determined according to Table 1 below

TABLE 1
Example

Quantity of symbols

| μ | Z₁ | Z′₁ |
|---|---|---|
| 0 | 10 | 8 |
| 1 | 13 | 11 |
| 2 | 25 | 21 |
| 3 | 43 | 36 |

In Table 1, μ may correspond to a subcarrier spacing (SCS) associated with the UE 120, such as a subcarrier spacing associated with a downlink channel for the UE 120 (such as a physical downlink control channel (PDCCH), represented by μ_{PDCCH}), an SCS associated with the TRS (e.g., represented by μ_{TRS}), or an SCS association with an uplink channel for the UE 120 (such as a physical uplink shared channel (PUSCH), represented by μ_{UL}). In some aspects, the UE 120 may use a minimum of μ_{PDCCH}, μ_{TRS}, or μ_{UL} to determine Z₁ or Z′₁ from Table 1.

In another example, the quantity of symbols may be represented by Z₁, Z′₁, Z₂, Z′₂, Z₃, or Z′₃ and determined according to Table 2 below

TABLE 2
Example

| | | |
|---|---|---|
| Quantity of | Quantity of | Quantity of |
| symbols | symbols | symbols |

| μ | Z₁ | Z′₁ | Z₂ | Z′₂ | Z₃ | Z′₃ |
|---|---|---|---|---|---|---|
| 0 | 22 | 16 | 40 | 37 | 22 | X₀ |
| 1 | 33 | 30 | 72 | 69 | 33 | X₁ |
| 2 | 44 | 42 | 141 | 140 | min(44, | X₂ |
| | | | | | X₂ + KB₁) | |
| 3 | 97 | 85 | 152 | 140 | min(97, | X₃ |
| | | | | | X₃ + KB₂) | |
| 5 | 388 | 340 | 608 | 560 | min(388, | X₅ |
| | | | | | X₅ + KB₃) | |
| 6 | 776 | 680 | 1216 | 1120 | min(776, | X₆ |
| | | | | | X₆ + KB₄) | |

In Table 2, μ may correspond to a SCS associated with the UE 120, as described in connection with Table 1. Additionally, X_{μ} may be based on a capability associated with the UE 120 (e.g., a beam report timing) and determined according to 3GPP specifications. Similarly, KB₁, KB₂, KB₃, KB₄ may be based on a capability associated with the UE 120 (e.g., a beam switch timing) and determined according to 3GPP specifications.

Additionally, the report may be associated with a CSI reference resource in a downlink slot that is prior to an uplink slot in which the report is transmitted (e.g., represented by n′) by a quantity of slots (e.g., represented by n_{CSI_ref}). For example, when the TRS is associated with a single set of CSI resources, the CSI reference resources may be in a downlink slot at least four slots prior (e.g., n_{CSI_ref} is the smallest value greater than or equal to 4). Similarly, when the TRS is associated with multiple sets of CSI resources, the CSI reference resources may be in a downlink slot at least five slots prior (e.g., n_{CSI_ref} is the smallest value greater than or equal to 5). Alternatively, the CSI reference resource may be in downlink slot that is at least └Z′/N_{symb}^{slot}┘ slots prior to the uplink slot in which the report is transmitted, where Z′ is calculated as described above and N_{symb}^{slot} represents a quantity of symbols within each slot. Accordingly, n_{CSI_ref} or └Z′/N_{symb}^{slot}┘ may be referred to as a “delay requirement” associated with the report. Alternatively, the CSI reference resource may be included in a same slot as DCI associated with the report (e.g., as described in connection with reference number 515).

In some aspects, the UE 120 may calculate the Doppler shift based on only a most recent instance of the TRS that is received no later than the CSI reference resource, as described above, associated with the report. In some aspects, the UE 120 may use only the most recent instance of the TRS when a timeRestrictionForChannelMeasurements variable (e.g., as described in 3GPP specifications and/or another stand) is set to Configured. Accordingly, in some aspects, the UE 120 may use additional instances of the TRS when the timeRestrictionForChannelMeasurements variable (e.g., as described in 3GPP specifications and/or another stand) is set to notConfigured.

In order to generate the report, the UE 120 may occupy zero central processing units (CPUs) associated with the UE 120 from measuring the TRS to transmitting the report. Accordingly, the occupied CPUs may be represented by O_{CPU}^{TRS}=0 when the network entity 501 transmits a CSI-ReportConfig data structure, as described in connection with reference number 510, with a variable reportQuantity not set to ‘none’ (e.g., as described in 3GPP specifications and/or another standard).

Alternatively, the UE 120 may occupy one or more CPUs associated with the UE 120 from measuring the TRS to transmitting the report. Accordingly, in one example, the occupied CPUs may be represented by O_{CPU}^{TRS}=1 when the network entity 501 transmits a CSI-ReportConfig data structure, as described in connection with reference number 510, indicating the TRS.

In some aspects, the UE 120 may occupy CPUs associated with the UE 120 from a first symbol of an earliest reference signal (e.g., an earliest symbol including the TRS in the earliest burst of the TRS) in a measurement duration (e.g., as described in connection with FIGS. 6A, 6B, and 6C) associated with the report until a last symbol carrying the report. Alternatively, the UE 120 may occupy CPUs associated with the UE 120 from a first symbol of DCI associated with the report until a last symbol carrying the report.

By using techniques as described in connection with FIG. 5, the network entity 501 may configure the UE 120 to measure a Doppler shift using the TRS. As a result, the network entity 501 may conserve power and processing resources by using a TRS to obtain a Doppler shift associated with the UE 120 as compared with transmitting a new CSI-RS or set of CSI-RSs. Additionally, the network entity 501 may obtain higher resolution for the Doppler shift by using a longer measurement duration associated with the TRS as compared with a shorter measurement duration associated with a CSI-RS (or a set of CSI-RSs).

As indicated above, FIG. 5 is provided as an example. Other examples may differ from what is described with respect to FIG. 5.

FIGS. 6A, 6B, and 6C are diagram illustrating examples 600, 620, and 640, respectively, associated with measurement durations for a TRS, in accordance with the present disclosure. As shown in FIGS. 6A, 6B, and 6C, a plurality of slots 601a, 601b, 601c, 601d, 601e, 601f, 601g, 601h, 601i, 601j, 601k, and 601l are shown.

As shown in FIG. 6A, in example 600, the TRS extends across four slots. For example, a first burst of the TRS extends across slots 601a, 601b, 601c, and 601d. As described in connection with FIG. 4, the first burst of the TRS may be evenly distributed across symbols of slots 601a, 601b, 601c, and 601d. Additionally, in example 600, the TRS is periodic (or at least semi-persistent). Accordingly, the TRS repeats according to periodicity 603. Although shown as eight slots, the periodicity 603 may be longer (e.g., 10 milliseconds (ms), 20 ms, and so on). As a result, a second burst of the TRS extends across slots 601i, 601j, 601k, and 601l.

Accordingly, a UE (e.g., UE 120) measuring a single burst of the TRS in example 600 may measure for a duration 605. Because the UE 120 measures a single burst of a P-TRS, the duration 605 is smaller than the periodicity 603. Although described in connection with the TRS extending across four slots, the description similarly applies to the TRS extending across fewer slots (e.g., three slots) or additional slots (e.g., five slots, six slots, and so on).

As shown in FIG. 6B, in example 620, the TRS extends across two slots. For example, a first burst of the TRS extends across slots 601a and 601b. As described in connection with FIG. 4, the first burst of the TRS may be evenly distributed across symbols of slots 601a and 601b. Additionally, in example 620, the TRS is periodic (or at least semi-persistent). Accordingly, the TRS repeats according to periodicity 623. Although shown as four slots, the periodicity 623 may be longer (e.g., 10 ms, 20 ms, and so on). As a result, a second burst of the TRS extends across slots 601e and 601f, and a third burst of the TRS extends across slots 601i and 601j.

Accordingly, a UE (e.g., UE 120) may measure multiple bursts of the TRS in example 620 for a duration 625. Because the UE 120 measures multiple bursts of a P-TRS, the duration 625 is larger than the periodicity 623. Although described in connection with the TRS extending across two slots, the description similarly applies to the TRS extending across one slot. Alternatively, in some aspects, example 620 may be combined with example 600 such that the UE 120 measures multiple bursts of a TRS, where each burst extends across more than two slots.

As shown in FIG. 6C, in example 640, a P-TRS (or an SP-TRS) extends across two slots as does an A-TRS. For example, a first burst of the P-TRS extends across slots 601a and 601b, and the A-TRS extends across slots 601c and 601d. As described in connection with FIG. 4, the first burst of the P-TRS may be evenly distributed across symbols of slots 601a and 601b. Additionally, in example 640, the P-TRS repeats according to periodicity 643. Although shown as eight slots, the periodicity 643 may be longer (e.g., 10 ms, 20 ms, and so on). As a result, a second burst of the P-TRS extends across slots 60li and 601j. The A-TRS does not repeat.

Accordingly, a UE (e.g., UE 120) may measure a burst of the P-TRS in combination with the A-TRS for a duration 645. In some aspects, the duration 645 is thus smaller than the periodicity 643, as shown in FIG. 6C. Alternatively, the duration 645 may be larger than the periodicity 643, depending on how far apart in time the P-TRS is from the A-TRS.

In order to determine which burst of the P-TRS to measure in combination with the A-TRS, the UE 120 may measure a burst of the P-TRS closest in time to the A-TRS. The UE 120 may determine the burst absolutely closest, closest in time prior to the A-TRS, or closest in time after the A-TRS. Alternatively, the UE 120 may measure a burst of the P-TRS that is separated in time from the A-TRS by an interval that satisfies an interval threshold. For example, the UE 120 may measure a burst of the P-TRS that is separate in time from the A-TRS by an interval that is at least one symbol (or at least one slot) but also satisfies the interval threshold. The UE 120 may determine check for bursts both earlier and later in time than the A-TRS that satisfy the interval threshold, for only bursts that are earlier in time than the A-TRS that satisfy the interval threshold, or for only bursts that are later in time than the A-TRS that satisfy the interval threshold.

In some aspects, the UE 120 may receive DCI to trigger measurement (e.g., as described in connection with reference number 515 of FIG. 5). Accordingly, the DCI may indicate a burst of the P-TRS to measure (e.g., using an offset from the A-TRS and/or another indicator associated with the burst to measure).

Although described in connection with the P-TRS extending across two slots, the description similarly applies to the P-TRS extending across one slot. Alternatively, in some aspects, example 640 may be combined with example 600 such that the UE 120 measures a burst of a P-TRS in combination with an A-TRS, where the burst of the P-TRS extends across more than two slots. Additionally, or alternatively, in some aspects, example 640 may be combined with example 620 such that the UE 120 measures multiple bursts of a P-TRS in combination with an A-TRS. In any aspects described above, the UE 120 may measure one or more bursts of a P-TRS in combination with multiple A-TRSs.

The P-TRS and the one or more A-TRSs may be associated with a same bandwidth and a same transmission configuration indicator (TCI) state. For example, the P-TRS and the one or more A-TRSs may be associated with corresponding TCI-state data structures (e.g., as described in 3GPP specifications and/or another standard) that indicate a same quasi-co-location (QCL) property. For example, the data structures may indicate a same QCL-typeA and/or a same QCL-typeD property (e.g., as described in 3GPP specifications and/or another standard). As a result, the UE 120 may combine measurements of the P-TRS with measurements of the A-TRS(s) to determine a Doppler shift value without decreasing accuracy of the Doppler shift value.

In order to indicate that the UE 120 should measure at least one burst of the P-TRS in combination with at least one A-TRS, a network entity (e.g., network entity 501) may transmit a configuration that indicates at least a first set of CSI resources comprising the P-TRS and a second set of CSI resources comprising the A-TRS. For example, the network entity 501 may transmit a CSI-ReportConfig data structure (e.g., as described in 3GPP specifications and/or another standard) that indicates multiple NZP-CSI-RS-ResourceSet data structures, where one NZP-CSI-RS-ResourceSet data structure indicates the P-TRS and a different NZP-CSI-RS-ResourceSet data structure indicates the A-TRS. Additionally, the network entity 501 may indicate multiple resource Type variables (e.g., as described in 3GPP specifications and/or another standard) associated with the CSI-ReportConfig data structure rather than a single resource Type variable because the UE 120 will be measuring one set of CSI resources that is periodic (or at least semi-persistent) and a different set of CSI resources that is aperiodic.

As indicated above, FIGS. 6A, 6B, and 6C are provided as examples. Other examples may differ from what is described with respect to FIGS. 6A, 6B, and 6C.

FIG. 7 is a diagram illustrating an example process 700 performed, for example, by a UE, in accordance with the present disclosure. Example process 700 is an example where the UE (e.g., UE 120 and/or apparatus 900 of FIG. 9) performs operations associated with Doppler shift reporting using a TRS.

As shown in FIG. 7, in some aspects, process 700 may include measuring a TRS to determine a Doppler shift associated with the UE (block 710). For example, the UE (e.g., using communication manager 140 and/or measurement component 908, depicted in FIG. 9) may measure a TRS to determine a Doppler shift associated with the UE, as described herein.

As further shown in FIG. 7, in some aspects, process 700 may include transmitting a report indicating a quantized value of the Doppler shift (block 720). For example, the UE (e.g., using communication manager 140 and/or transmission component 904, depicted in FIG. 9) may transmit a report indicating a quantized value of the Doppler shift, as described herein. In some aspects, the quantized value is based at least in part on a duration associated with measuring the TRS and an interval associated with the TRS.

Process 700 may include additional aspects, such as any single aspect or any combination of aspects described below and/or in connection with one or more other processes described elsewhere herein.

In a first aspect, the quantized value includes one or more bits indicating a range for the Doppler shift, and the range is based at least in part on a maximum value.

In a second aspect, alone or in combination with the first aspect, the maximum value is a default value calculated (e.g., using communication manager 140 and/or determination component 910, depicted in FIG. 9) using the duration associated with measuring the TRS and the interval associated with the TRS.

In a third aspect, alone or in combination with one or more of the first and second aspects, process 700 further includes receiving (e.g., using communication manager 140 and/or reception component 902, depicted in FIG. 9), from a network entity, an indication of the maximum value.

In a fourth aspect, alone or in combination with one or more of the first through third aspects, process 700 further includes transmitting (e.g., using communication manager 140 and/or transmission component 904), to a network entity, an indication of the maximum value.

In a fifth aspect, alone or in combination with one or more of the first through fourth aspects, the quantized value is further based, at least in part, on a carrier frequency associated with the TRS.

In a sixth aspect, alone or in combination with one or more of the first through fifth aspects, the TRS is periodic, and a burst of the TRS is longer than two slots.

In a seventh aspect, alone or in combination with one or more of the first through sixth aspects, the TRS is periodic, and the TRS is measured across a plurality of bursts.

In an eighth aspect, alone or in combination with one or more of the first through seventh aspects, a periodic TRS is measured in combination with an aperiodic TRS.

In a ninth aspect, alone or in combination with one or more of the first through eighth aspects, process 700 further includes receiving (e.g., using communication manager 140 and/or reception component 902) a configuration associated with the report, the configuration indicating a first set of CSI resources comprising the periodic TRS and a second set of CSI resources comprising the aperiodic TRS.

In a tenth aspect, alone or in combination with one or more of the first through ninth aspects, the periodic TRS and the aperiodic TRS are associated with a same bandwidth and a same TCI state.

In an eleventh aspect, alone or in combination with one or more of the first through tenth aspects, measuring the periodic TRS in combination with the aperiodic TRS includes measuring a burst of the periodic TRS closest in time to the aperiodic TRS.

In a twelfth aspect, alone or in combination with one or more of the first through eleventh aspects, measuring the periodic TRS in combination with the aperiodic TRS includes measuring a burst of the periodic TRS that is separated in time from the aperiodic TRS by an interval that satisfies an interval threshold.

In a thirteenth aspect, alone or in combination with one or more of the first through twelfth aspects, process 700 further includes receiving (e.g., using communication manager 140 and/or reception component 902) DCI associated with the report, the DCI indicating a burst of the periodic TRS to measure.

In a fourteenth aspect, alone or in combination with one or more of the first through thirteenth aspects, transmitting the report includes transmitting the report a quantity of symbols, corresponding to a computation time, after receiving DCI associated with the report or a latest TRS resource that was measured, where the quantity of symbols is based on an SCS associated with the UE.

In a fifteenth aspect, alone or in combination with one or more of the first through fourteenth aspects, the TRS is associated with a single set of CSI resources, and a CSI reference resource associated with the report is at least four slots prior to a slot used to transmit the report.

In a sixteenth aspect, alone or in combination with one or more of the first through fifteenth aspects, the TRS is associated with multiple sets of CSI resources, and a CSI reference resource associated with the report is at least five slots prior to a slot used to transmit the report.

In a seventeenth aspect, alone or in combination with one or more of the first through sixteenth aspects, the TRS is aperiodic, and a CSI reference resource associated with the report is in a same slot as DCI associated with the report.

In an eighteenth aspect, alone or in combination with one or more of the first through seventeenth aspects, the TRS is aperiodic, and a CSI reference resource associated with the report is in a slot based at least in part on a delay requirement associated with the report.

In a nineteenth aspect, alone or in combination with one or more of the first through eighteenth aspects, the Doppler shift is based on only a most recent burst of the TRS that is received no later than a CSI reference resource associated with the report.

In a twentieth aspect, alone or in combination with one or more of the first through nineteenth aspects, process 700 further includes occupying (e.g., using communication manager 140 and/or measurement component 908) one or more CPUs associated with the UE from measuring to transmitting.

In a twenty-first aspect, alone or in combination with one or more of the first through twentieth aspects, process 700 further includes occupying (e.g., using communication manager 140 and/or measurement component 908) zero CPUs associated with the UE from measuring to transmitting.

In a twenty-second aspect, alone or in combination with one or more of the first through twenty-first aspects, process 700 further includes occupying (e.g., using communication manager 140 and/or measurement component 908) a quantity of CPUs associated with the UE from a first symbol of an earliest reference signal in a measurement duration associated with the report until a last symbol carrying the report.

In a twenty-third aspect, alone or in combination with one or more of the first through twenty-second aspects, process 700 further includes occupying (e.g., using communication manager 140 and/or measurement component 908) a quantity of CPUs associated with the UE from a first symbol of DCI associated with the report until a last symbol carrying the report.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network entity, in accordance with the present disclosure. Example process 800 is an example where the network entity (e.g., apparatus 1000 of FIG. 10 and/or network entity 501, such as a base station 110, a CU 310, a DU 330, and/or an RU 340) performs operations associated with Doppler shift reporting using a TRS.

As shown in FIG. 8, in some aspects, process 800 may include transmitting a configuration associated with a TRS (block 810). For example, the network entity (e.g., using communication manager 150 and/or transmission component 1004, depicted in FIG. 10) may transmit a configuration associated with a TRS, as described herein.

As further shown in FIG. 8, in some aspects, process 800 may include receiving a report indicating a quantized value of a Doppler shift associated with a UE (block 820). For example, the network entity (e.g., using communication manager 150 and/or reception component 1002, depicted in FIG. 10) may receive a report indicating a quantized value of a Doppler shift associated with a UE, as described herein. In some aspects, the quantized value is based at least in part on a duration associated with measuring the TRS and an interval associated with the TRS.

Process 800 may include additional aspects, such as any single aspect or any combination of aspects described below and/or in connection with one or more other processes described elsewhere herein.

In a first aspect, the quantized value includes one or more bits indicating a range for the Doppler shift, and the range is based at least in part on a maximum value.

In a second aspect, alone or in combination with the first aspect, the maximum value is a default value calculated (e.g., using communication manager 150 and/or determination component 1008, depicted in FIG. 10) using the duration associated with measuring the TRS and the interval associated with the TRS.

In a third aspect, alone or in combination with one or more of the first and second aspects, process 800 further includes transmitting (e.g., using communication manager 150 and/or transmission component 1004) an indication of the maximum value.

In a fourth aspect, alone or in combination with one or more of the first through third aspects, process 800 further includes receiving (e.g., using communication manager 150 and/or reception component 1002) an indication of the maximum value.

In a fifth aspect, alone or in combination with one or more of the first through fourth aspects, the quantized value is further based, at least in part, on a carrier frequency associated with the TRS.

In a sixth aspect, alone or in combination with one or more of the first through fifth aspects, the TRS is periodic, and a burst of the TRS is longer than two slots.

In a seventh aspect, alone or in combination with one or more of the first through sixth aspects, the TRS is periodic, and the report is based on measurements of the TRS across a plurality of bursts.

In an eighth aspect, alone or in combination with one or more of the first through seventh aspects, the report is based on measurements of a periodic TRS in combination with an aperiodic TRS.

In a ninth aspect, alone or in combination with one or more of the first through eighth aspects, process 800 further includes transmitting (e.g., using communication manager 150 and/or transmission component 1004) a configuration associated with the report, the configuration indicating a first set of CSI resources comprising the periodic TRS and a second set of CSI resources comprising the aperiodic TRS.

In a tenth aspect, alone or in combination with one or more of the first through ninth aspects, the periodic TRS and the aperiodic TRS are associated with a same bandwidth and a same TCI state.

In an eleventh aspect, alone or in combination with one or more of the first through tenth aspects, the report is based on measurements of a burst of the periodic TRS closest in time to the aperiodic TRS.

In a twelfth aspect, alone or in combination with one or more of the first through eleventh aspects, the report is based on measurements of a burst of the periodic TRS that is separated in time from the aperiodic TRS by an interval that satisfies an interval threshold.

In a thirteenth aspect, alone or in combination with one or more of the first through twelfth aspects, process 800 further includes transmitting (e.g., using communication manager 150 and/or transmission component 1004, depicted in FIG. 10) DCI associated with the report, the DCI indicating a burst of the periodic TRS to measure.

In a fourteenth aspect, alone or in combination with one or more of the first through thirteenth aspects, receiving the report includes receiving the report a quantity of symbols, corresponding to a computation time, after transmitting DCI associated with the report or a latest TRS resource that was measured, where the quantity of symbols is based on an SCS associated with the UE.

In a fifteenth aspect, alone or in combination with one or more of the first through fourteenth aspects, the TRS is associated with a single set of CSI resources, and a CSI reference resource associated with the report is at least four slots prior to a slot used to transmit the report.

In a sixteenth aspect, alone or in combination with one or more of the first through fifteenth aspects, the TRS is associated with multiple sets of CSI resources, and a CSI reference resource associated with the report is at least five slots prior to a slot used to transmit the report.

In a seventeenth aspect, alone or in combination with one or more of the first through sixteenth aspects, the TRS is aperiodic, and a CSI reference resource associated with the report is in a same slot as DCI associated with the report.

In an eighteenth aspect, alone or in combination with one or more of the first through seventeenth aspects, the TRS is aperiodic, and a CSI reference resource associated with the report is in a slot based at least in part on a delay requirement associated with the report.

In a nineteenth aspect, alone or in combination with one or more of the first through eighteenth aspects, the Doppler shift is based on only a most recent burst of the TRS that is transmitted no later than a CSI reference resource associated with the report.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of a measurement component 908 and/or a determination component 910, among other examples.

In some aspects, the apparatus 900 may be configured to perform one or more operations described herein in connection with FIGS. 4, 5, 6A, 6B, and 6C. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

In some aspects, the measurement component 908 may measure a TRS to determine a Doppler shift associated with the apparatus 900. The measurement component 908 may include one or more antennas, a modem, a demodulator, a MIMO detector, a receive processor, a controller/processor, a memory, or a combination thereof, of the UE described in connection with FIG. 2. Accordingly, the transmission component 904 may transmit a report indicating a quantized value of the Doppler shift. The quantized value may be based at least in part on a duration associated with measuring the TRS and an interval associated with the TRS. For example, the determination component 910 may calculate a maximum value such that the quantized value is based on the maximum value. The determination component 910 may include a MIMO detector, a receive processor, a transmit MIMO processor, a transmit processor, a controller/processor, a memory, or a combination thereof, of the UE described in connection with FIG. 2.

Accordingly, the transmission component 904 may transmit (e.g., to a network entity, such as apparatus 906) an indication of the maximum value. Alternatively, the reception component 902 may receive (e.g., from the network entity) an indication of the maximum value.

In some aspects, the reception component 902 may receive a configuration, associated with the report, that indicates a first set of CSI resources comprising a periodic TRS and a second set of CSI resources comprising an aperiodic TRS. Accordingly, the reception component 902 may receive DCI, associated with the report, that indicates a burst of the periodic TRS to measure.

In some aspects, the measurement component 908 may occupy one or more CPUs associated with the apparatus 900 from measuring the TRS to transmitting the report. Alternatively, the measurement component 908 may occupy zero CPUs associated with the apparatus 900 from measuring the TRS to transmitting the report.

In some aspects, the measurement component 908 may occupy a quantity of CPUs associated with the apparatus 900 from a first symbol of an earliest reference signal in a measurement duration associated with the report until a last symbol carrying the report. Alternatively, the measurement component 908 may occupy a quantity of CPUs associated with the apparatus 900 from a first symbol of DCI associated with the report until a last symbol carrying the report.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network entity, or a network entity may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include a determination component 1008, among other examples.

In some aspects, the apparatus 1000 may be configured to perform one or more operations described herein in connection with FIGS. 4, 5, 6A, 6B, and 6C. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the base station described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the base station described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the base station described in connection with FIG. 2. In some aspects, the transmission component 1004 may be co-located with the reception component 1002 in a transceiver.

In some aspects, the transmission component 1004 may transmit a configuration associated with a TRS. Accordingly, the reception component 1002 may receive a report indicating a quantized value of a Doppler shift (e.g., associated with a UE, such as the apparatus 1006).

The quantized value may be based at least in part on a duration associated with measuring the TRS and an interval associated with the TRS. For example, the determination component 1008 may calculate a maximum value such that the quantized value is based on the maximum value. The determination component 1008 may include a MIMO detector, a receive processor, a transmit MIMO processor, a transmit processor, a controller/processor, a memory, or a combination thereof, of the base station described in connection with FIG. 2.

Accordingly, the transmission component 904 may transmit an indication of the maximum value. Alternatively, the reception component 902 may receive an indication of the maximum value.

In some aspects, the transmission component 1004 may transmit a configuration, associated with the report, that indicates a first set of CSI resources comprising a periodic TRS and a second set of CSI resources comprising an aperiodic TRS. Accordingly, the transmission component 1004 may transmit DCI, associated with the report, that indicates a burst of the periodic TRS to measure.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: measuring a tracking reference signal (TRS) to determine a Doppler shift associated with the UE; and transmitting a report indicating a quantized value of the Doppler shift, wherein the quantized value is based at least in part on a duration associated with measuring the TRS and an interval associated with the TRS.

Aspect 2: The method of Aspect 1, wherein the quantized value includes one or more bits indicating a range for the Doppler shift, wherein the range is based at least in part on a maximum value.

Aspect 3: The method of Aspect 2, wherein the maximum value is a default value calculated using the duration associated with measuring the TRS and the interval associated with the TRS.

Aspect 4: The method of any of Aspects 2 through 3, further comprising: receiving, from a network entity, an indication of the maximum value.

Aspect 5: The method of any of Aspects 2 through 3, further comprising: transmitting, to a network entity, an indication of the maximum value.

Aspect 6: The method of any of Aspects 1 through 5, wherein the quantized value is further based, at least in part, on a carrier frequency associated with the TRS.

Aspect 7: The method of any of Aspects 1 through 6, wherein the TRS is periodic, and wherein a burst of the TRS is longer than two slots.

Aspect 8: The method of any of Aspects 1 through 6, wherein the TRS is periodic, and wherein measuring the TRS comprises: measuring the TRS across a plurality of bursts.

Aspect 9: The method of any of Aspects 1 through 6, wherein measuring the TRS comprises: measuring a periodic TRS in combination with an aperiodic TRS.

Aspect 10: The method of Aspect 9, further comprising: receiving a configuration associated with the report, wherein the configuration indicates a first set of channel state information (CSI) resources comprising the periodic TRS and a second set of CSI resources comprising the aperiodic TRS.

Aspect 11: The method of any of Aspects 9 through 10, wherein the periodic TRS and the aperiodic TRS are associated with a same bandwidth and a same transmission configuration indicator (TCI) state.

Aspect 12: The method of any of Aspects 9 through 11, wherein measuring the periodic TRS in combination with the aperiodic TRS comprises: measuring a burst of the periodic TRS closest in time to the aperiodic TRS.

Aspect 13: The method of any of Aspects 9 through 11, wherein measuring the periodic TRS in combination with the aperiodic TRS comprises: measuring a burst of the periodic TRS that is separated in time from the aperiodic TRS by an interval that satisfies an interval threshold.

Aspect 14: The method of any of Aspects 9 through 11, further comprising: receiving downlink control information (DCI) associated with the report, wherein the DCI indicates a burst of the periodic TRS to measure.

Aspect 15: The method of any of Aspects 1 through 14, wherein transmitting the report comprises: transmitting the report a quantity of symbols, corresponding to a computation time, after receiving downlink control information (DCI) associated with the report or a latest TRS resource that was measured, wherein the quantity of symbols is based on a subcarrier spacing associated with the UE.

Aspect 16: The method of any of Aspects 1 through 15, wherein the TRS is associated with a single set of channel state information (CSI) resources, and a CSI reference resource associated with the report is at least four slots prior to a slot used to transmit the report.

Aspect 17: The method of any of Aspects 1 through 15, wherein the TRS is associated with multiple sets of channel state information (CSI) resources, and a CSI reference resource associated with the report is at least five slots prior to a slot used to transmit the report.

Aspect 18: The method of any of Aspects 1 through 15, wherein the TRS is aperiodic, and a CSI reference resource associated with the report is in a same slot as downlink control information (DCI) associated with the report.

Aspect 19: The method of any of Aspects 1 through 15, wherein the TRS is aperiodic, and a CSI reference resource associated with the report is in a slot based at least in part on a delay requirement associated with the report.

Aspect 20: The method of any of Aspects 1 through 19, wherein the Doppler shift is based on only a most recent burst of the TRS that is received no later than a CSI reference resource associated with the report.

Aspect 21: The method of any of Aspects 1 through 20, further comprising: occupying one or more central processing units (CPUs) associated with the UE from measuring to transmitting.

Aspect 22: The method of any of Aspects 1 through 20, further comprising: occupying zero central processing units (CPUs) associated with the UE from measuring to transmitting.

Aspect 23: The method of any of Aspects 1 through 22, further comprising: occupying a quantity of central processing units (CPUs) associated with the UE from a first symbol of an earliest reference signal in a measurement duration associated with the report until a last symbol carrying the report.

Aspect 24: The method of any of Aspects 1 through 22, further comprising: occupying a quantity of central processing units (CPUs) associated with the UE from a first symbol of downlink control information (DCI) associated with the report until a last symbol carrying the report.

Aspect 25: A method of wireless communication performed by a network entity, comprising: transmitting a configuration associated with a tracking reference signal (TRS); and receiving a report indicating a quantized value of a Doppler shift associated with a user equipment (UE), wherein the quantized value is based at least in part on a duration associated with measuring the TRS and an interval associated with the TRS.

Aspect 26: The method of Aspect 25, wherein the quantized value includes one or more bits indicating a range for the Doppler shift, wherein the range is based at least in part on a maximum value.

Aspect 27: The method of Aspect 26, wherein the maximum value is a default value calculated using the duration associated with measuring the TRS and the interval associated with the TRS.

Aspect 28: The method of any of Aspects 26 through 27, further comprising: transmitting an indication of the maximum value.

Aspect 29: The method of any of Aspects 26 through 27, further comprising: receiving an indication of the maximum value.

Aspect 30: The method of any of Aspects 25 through 29, wherein the quantized value is further based, at least in part, on a carrier frequency associated with the TRS.

Aspect 31: The method of any of Aspects 25 through 30, wherein the TRS is periodic, and wherein a burst of the TRS is longer than two slots.

Aspect 32: The method of any of Aspects 25 through 30, wherein the TRS is periodic, and wherein the report is based on measurements of the TRS across a plurality of bursts.

Aspect 33: The method of any of Aspects 25 through 30, wherein the report is based on measurements of a periodic TRS in combination with an aperiodic TRS.

Aspect 34: The method of Aspect 33, further comprising: transmitting a configuration associated with the report, wherein the configuration indicates a first set of channel state information (CSI) resources comprising the periodic TRS and a second set of CSI resources comprising the aperiodic TRS.

Aspect 35: The method of any of Aspects 33 through 34, wherein the periodic TRS and the aperiodic TRS are associated with a same bandwidth and a same transmission configuration indicator (TCI) state.

Aspect 36: The method of any of Aspects 33 through 35, wherein the report is based on measurements of a burst of the periodic TRS closest in time to the aperiodic TRS.

Aspect 37: The method of any of Aspects 33 through 35, wherein the report is based on measurements of a burst of the periodic TRS that is separated in time from the aperiodic TRS by an interval that satisfies an interval threshold.

Aspect 38: The method of any of Aspects 33 through 35, further comprising: transmitting downlink control information (DCI) associated with the report, wherein the DCI indicates a burst of the periodic TRS to measure.

Aspect 39: The method of any of Aspects 25 through 38, wherein receiving the report comprises: receiving the report a quantity of symbols, corresponding to a computation time, after transmitting downlink control information (DCI) associated with the report or a latest TRS resource that was measured, wherein the quantity of symbols is based on a subcarrier spacing associated with the UE.

Aspect 40: The method of any of Aspects 25 through 39, wherein the TRS is associated with a single set of channel state information (CSI) resources, and a CSI reference resource associated with the report is at least four slots prior to a slot used to transmit the report.

Aspect 41: The method of any of Aspects 25 through 39, wherein the TRS is associated with multiple sets of channel state information (CSI) resources, and a CSI reference resource associated with the report is at least five slots prior to a slot used to transmit the report.

Aspect 42: The method of any of Aspects 25 through 39, wherein the TRS is aperiodic, and a CSI reference resource associated with the report is in a same slot as downlink control information (DCI) associated with the report.

Aspect 43: The method of any of Aspects 25 through 39, wherein the TRS is aperiodic, and a CSI reference resource associated with the report is in a slot based at least in part on a delay requirement associated with the report.

Aspect 44: The method of any of Aspects 25 through 43, wherein the Doppler shift is based on only a most recent burst of the TRS that is transmitted no later than a CSI reference resource associated with the report.

Aspect 45: An apparatus for wireless communication at a device, comprising a processor; memory coupled with the processor; and instructions stored in the memory and executable by the processor to cause the apparatus to perform the method of one or more of Aspects 1-24.

Aspect 46: A device for wireless communication, comprising a memory and one or more processors coupled to the memory, the one or more processors configured to perform the method of one or more of Aspects 1-24.

Aspect 47: An apparatus for wireless communication, comprising at least one means for performing the method of one or more of Aspects 1-24.

Aspect 48: A non-transitory computer-readable medium storing code for wireless communication, the code comprising instructions executable by a processor to perform the method of one or more of Aspects 1-24.

Aspect 49: A non-transitory computer-readable medium storing a set of instructions for wireless communication, the set of instructions comprising one or more instructions that, when executed by one or more processors of a device, cause the device to perform the method of one or more of Aspects 1-24.

Aspect 50: An apparatus for wireless communication at a device, comprising a processor; memory coupled with the processor; and instructions stored in the memory and executable by the processor to cause the apparatus to perform the method of one or more of Aspects 25-44.

Aspect 51: A device for wireless communication, comprising a memory and one or more processors coupled to the memory, the one or more processors configured to perform the method of one or more of Aspects 25-44.

Aspect 52: An apparatus for wireless communication, comprising at least one means for performing the method of one or more of Aspects 25-44.

Aspect 53: A non-transitory computer-readable medium storing code for wireless communication, the code comprising instructions executable by a processor to perform the method of one or more of Aspects 25-44.

Aspect 54: A non-transitory computer-readable medium storing a set of instructions for wireless communication, the set of instructions comprising one or more instructions that, when executed by one or more processors of a device, cause the device to perform the method of one or more of Aspects 25-44.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
one or more memories; and
one or more processors, coupled to the one or more memories, configured to:
measure a tracking reference signal (TRS) to determine a measurement using the TRS; and
transmit a report indicating the measurement,
wherein the report is transmitted a quantity of symbols, corresponding to a computation time, after receiving downlink control information (DCI) associated with the report or a latest TRS resource that was measured, and wherein the quantity of symbols is based on a subcarrier spacing associated with the UE.

2-6. (canceled)

7. The apparatus of claim 1, wherein the TRS is periodic, and wherein a burst of the TRS is longer than two slots.

8. The apparatus of claim 1, wherein the TRS is periodic, and wherein, to measure the TRS, the one or more processors are configured to:
measure the TRS across a plurality of bursts.

9. The apparatus of claim 1, wherein, to measure the TRS, the one or more processors are configured to:
measure a periodic TRS in combination with an aperiodic TRS.

10-18. (canceled)

19. The apparatus of claim 1, wherein the TRS is aperiodic, and a CSI reference resource associated with the report is in a slot based at least in part on a delay requirement associated with the report.

20. The apparatus of claim 1, wherein the measurement is based on a burst of the TRS that is received no later than a CSI reference resource associated with the report.

21. The apparatus of claim 1, wherein the one or more processors are further configured to:
occupy one or more central processing units (CPUs) associated with the UE from measuring to transmitting.

22. The apparatus of claim 1, wherein the one or more processors are further configured to:
occupy zero central processing units (CPUs) associated with the UE from measuring to transmitting.

23. The apparatus of claim 1, wherein the one or more processors are further configured to:
occupy a quantity of central processing units (CPUs) associated with the UE from a first symbol of an earliest reference signal in a measurement duration associated with the report until a last symbol carrying the report.

24. The apparatus of claim 1, wherein the one or more processors are further configured to:
occupy a quantity of central processing units (CPUs) associated with the UE from a first symbol of downlink control information (DCI) associated with the report until a last symbol carrying the report.

25. An apparatus for wireless communication at a network entity, comprising:
one or more memories; and
one or more processors, coupled to the one or more memories, configured to:
transmit a configuration associated with a tracking reference signal (TRS); and
receive a report indicating a quantized value of a Doppler shift associated with a user equipment (UE),
wherein the report is received a quantity of symbols, corresponding to a computation time, after transmitting downlink control information (DCI) associated with the report or a latest TRS resource that was measured, and
wherein the quantity of symbols is based on a subcarrier spacing associated with the UE.

26-30. (canceled)

31. The apparatus of claim 25, wherein the TRS is periodic, and wherein a burst of the TRS is longer than two slots.

32. The apparatus of claim 25, wherein the TRS is periodic, and wherein the report is based on measurements of the TRS across a plurality of bursts.

33-42. (anceled)

43. The apparatus of claim 25, wherein the TRS is aperiodic, and a CSI reference resource associated with the report is in a slot based at least in part on a delay requirement associated with the report.

44. The apparatus of claim 25, wherein the measurement is based on a burst of the TRS that is received no later than a CSI reference resource associated with the report.

45. A method of wireless communication performed by a user equipment (UE), comprising:
measuring a tracking reference signal (TRS) to determine a measurement using the TRS; and
transmitting a report indicating the measurement,
wherein the report is transmitted a quantity of symbols, corresponding to a computation time, after receiving downlink control information (DCI) associated with the report or a latest TRS resource that was measured, and
wherein the quantity of symbols is based on a subcarrier spacing associated with the UE.

46-50. (canceled)

51. The method of claim 45, wherein the TRS is periodic, and wherein a burst of the TRS is longer than two slots.

52. The method of claim 45, wherein the TRS is periodic, and wherein measuring the TRS comprises:
measuring the TRS across a plurality of bursts.

53. The method of claim 45, wherein measuring the TRS comprises:
measuring a periodic TRS in combination with an aperiodic TRS.

54. The method of claim 45, wherein the TRS is aperiodic, and a CSI reference resource associated with the report is in a slot based at least in part on a delay requirement associated with the report.

55. The method of claim 45, wherein the measurement is based on a burst of the TRS that is received no later than a CSI reference resource associated with the report.

56. The method of claim 45, further comprising:
occupying one or more central processing units (CPUs) associated with the UE from measuring to transmitting.

57. The method of claim 45, further comprising:
occupying zero central processing units (CPUs) associated with the UE from measuring to transmitting.

58. The method of claim 45, further comprising:
occupying a quantity of central processing units (CPUs) associated with the UE from a first symbol of an earliest reference signal in a measurement duration associated with the report until a last symbol carrying the report.

59. The method of claim 45, further comprising:
occupying a quantity of central processing units (CPUs) associated with the UE from a first symbol of downlink control information (DCI) associated with the report until a last symbol carrying the report.

60. A method of wireless communication performed by a network entity, comprising:
transmitting a configuration associated with a tracking reference signal (TRS); and
receiving a report indicating a quantized value of a Doppler shift associated with a user equipment (UE),
wherein the report is received a quantity of symbols, corresponding to a computation time, after transmitting downlink control information (DCI) associated with the report or a latest TRS resource that was measured, and
wherein the quantity of symbols is based on a subcarrier spacing associated with the UE.

61. The method of claim 60, wherein the TRS is periodic, and wherein a burst of the TRS is longer than two slots.

62. The method of claim 60, wherein the TRS is periodic, and wherein the report is based on measurements of the TRS across a plurality of bursts.

63. The method of claim 60, wherein the TRS is aperiodic, and a CSI reference resource associated with the report is in a slot based at least in part on a delay requirement associated with the report.

64. The method of claim 60, wherein the measurement is based on a burst of the TRS that is received no later than a CSI reference resource associated with the report.
